(19) United States
(12) Patent Application Publication
(10) Pub. No.: US 2018/0184314 A1
(43) Pub. Date: Jun. 28, 2018

(54) ENHANCED MEASUREMENT PROCEDURE

(71) Applicant: INTEL CORPORATION, SANTA CLARA, CA (US)

(72) Inventors: Yi ZHANG, Portland, OR (US); Rath VANNITHAMBY, Portland, OR (US); Mohammad Mamunur RASHID, Hillsboro, OR (US); Carlos CORDEIRO, Portland, OR (US); Arvind MERWADAY, Hillsboro, OR (US)

(21) Appl. No.: 15/390,871

(22) Filed: Dec. 27, 2016

(51) Int. Cl. H04W 24/10; H04L 29/08; H04W 28/10; H04L 12/24

(52) U.S. Cl. CPC H04W 24/10; H04L 69/324; H04W 84/12; H04L 41/0816; H04W 28/10

(57) ABSTRACT

Methods and devices are provided to send new or modified measurement requests and measurement reports during an announcement transmission interval (ATI). The measurement requests and measurement reports are used to determine the feasibility of spatial sharing in wireless local area networks (WLANs). New or modified measurement requests and measurement reports eliminate fields in the measurement request elements and measurement configuration information to lower or limit the overhead used in the ATI. These changes ensure the ATI does not become too long in duration and allows sharing measurement data during the ATI, even in dense WLAN environments.

### TECHNICAL FIELD

An exemplary aspect is directed toward communications systems. More specifically an exemplary aspect is directed toward wireless communications systems and even more specifically to IEEE (Institute of Electrical and Electronics Engineers) 802.11 wireless communications systems. Even more specifically, exemplary aspects are at least directed toward one or more of IEEE (Institute of Electrical and Electronics Engineers) 802.11n/ac/ax/ . . . communications systems and in general any wireless communications system or protocol, such as 4G, 4G LTE, 5G and later, and the like.

### BACKGROUND

Wireless networks transmit and receive information utilizing varying techniques and protocols. For example, but not by way of limitation, two common and widely adopted techniques used for communication are those that adhere to the Institute for Electronic and Electrical Engineers (IEEE) 802.11 standards such as the IEEE 802.11n standard, the IEEE 802.11ac standard, and the IEEE 802.11ax standard IEEE 802.11 ad standard, IEEE 802.11 ay standard, and current or future other IEEE 802.11 standards (802.11 a/b/g/n/ac/ax/af/ah/aj/ . . . ).

To accomplish high data rates, especially in densely-populated, wireless networks may employ spatial sharing. Spatial sharing attempts to transmit duplicate or multiple signals in the same frequency range to different physically-separated recipients and/or receivers. Such spatial sharing essentially doubles or multiples the available bandwidth of the wireless network.

Measurement of signal collision is necessary between the recipients and/or transmitters to allow or effect spatial sharing. Thus, stations (STAs) within the network conduct interference and other measurements and store the information in a measurement report(s). The Primary Control Point (PCP) access point (AP) PCP/AP can request the measurement reports from the various STAs and use the measurements to determine if spatial sharing is possible. However, obtaining the measurement reports can be problematic.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an embodiment of an environment for exchanging measurement reports;

FIG. 2 illustrates an embodiment of a signalling process for exchanging measurement reports;

FIG. 3A illustrates an embodiment of a data structure sent, received, and/or stored when for requesting and/or providing measurement reports;

FIG. 3B illustrates an embodiment of a data structure sent, received, and/or stored when for requesting and/or providing measurement reports;

FIG. 3C illustrates an embodiment of a data structure sent, received, and/or stored when for requesting and/or providing measurement reports;

FIG. 3D illustrates an embodiment of a data structure sent, received, and/or stored when for requesting and/or providing measurement reports;

FIG. 3E illustrates an embodiment of a data structure sent, received, and/or stored when for requesting and/or providing measurement reports;

FIG. 3F illustrates an embodiment of a data structure sent, received, and/or stored when for requesting and/or providing measurement reports;

FIG. 4 illustrates an embodiment of a method for requesting a measurement report;

FIG. 5 illustrates another embodiment of a method for requesting a measurement report;

FIG. 6 illustrates an embodiment of a method for providing a measurement report;

FIG. 7 illustrates another embodiment of a method for providing a measurement report;

FIG. 8 is an illustration of the hardware/software associated with a STA, a wireless device, and/or AP.

### DESCRIPTION OF EMBODIMENTS

Methods, devices, data structures, systems, etc. described herein provide for requesting and providing measurement reports with low overhead. A PCP/AP can request a STA, or one STA can request another STA, or one STA can request the PCP/AP to do a measurement by sending a measurement request. Measurement results are returned to the requester in a measurement report, which is generally sent in a Data Transmission Interval (DTI) or an Announcement Transmission Interval (ATI). When the measurement report is sent in the DTI, both the Scheduling Period (SP) and the Contention based Access Period (CBAP) can be used to transmit the measurement report. The measurement report can be transmitted along with data if a SP is allocated for data, or the measurement report can be transmitted at any time in the CBAP once the contention is successful.

However, contentions may fail in the CBAP, and thus, the measurement report must be postponed to the next CBAP, which may be located in the next Beacon Interval (BI). If the measurement report is needed to decide on spatial sharing in that BI, the PCP must wait until the measurement report is received, which may preclude spatial sharing. The problems are exacerbated in very dense networks in which numerous devices may contend the same CBAP resource.

Besides the DTI, another option to transmit the measurement report is during the ATI. The benefit of using the ATI for measurement messages is that the PCP/AP can control when the measurement reports are sent. The PCP/AP can then decide on spatial sharing and allocate the resource shortly after getting the measurement report in the same BI. The only requirement is that the measurement request/report shall follow the transmission rule in ATI. The transmission rule specifies that the PCP/AP initiates all frame exchanges that occur during the ATI, and a STA is not allowed to transmit during ATI except in response to the request from the PCP/AP. With this transmission rule, the STA must wait for a request from PCP/AP to trigger the measurement result reporting.

There is no requirement that the STA shall feedback a measurement report after the STA receives the request message. Thus, the STA's behavior is unpredictable. The unpredictability degrades the performance of spatial sharing because the PCP/AP has no insight to when the measurement report will arrive. Further, the current process for obtaining the measurement report requires significant bandwidth. For example, it is inefficient to resend a measurement request because the information is redundant. So, a technical problem exists in how to trigger the transmission of the measurement report using less bandwidth during the ATI.

Moreover, no mechanism forces the STA that sends a measurement request message to store the measurement configuration, the whole measurement configuration is repeated in the measurement report message to help the receiving STA recall what the measurement configuration is or was. Although this configuration provides the requesting STA more freedom to choose whether to keep or delete the configuration after sending the measurement request, the configuration causes more bandwidth usage (i.e., more overhead) because the measurement configuration is always carried even if the measurement configuration is stored in the peer STA. The overhead impacts the performance, especially when the reporting procedure occurs in the ATI where the resource is provided to multiple STAs. The more resource that is allocated to ATI necessarily means fewer resources are reserved to data transmission. And the situation is even worse in ultra-dense networks where numerous devices may report measurements to the AP. How do we reduce the overhead of measurement reporting?

### Technical Problem(s)

In summary, the measurement procedure is inefficient and requires too much overhead in both the measurement request and the measurement report. There is no mechanism to ensure STA feedback of the measurement report once the STA gets the request message in the ATI. To trigger the STA to send the measurement report requires too much overhead in ATI. Sending the measurement report also requires too much overhead.

### Technical Solution(s)

The embodiments presented herein provide devices, methods, data structures, etc. for providing efficient measurement requesting and reporting. First, an optional indicator placed into any message (not necessarily a measurement request) sent during the ATI can request another STA to report a measurement result. The messages with the optional indicator can include an announce message, an old measurement request which the PCP/AP already sent to the STA in the previous beacon interval, a new measurement request, and/or other messages. Second, the measurement request message, if sent, can be optimized to contain less overhead. Third, a new field is introduced in the measurement request to indicate whether the STA sending the measurement request will store the measurement configuration. With this new field, the STA sending the measurement report can choose or determine whether to send the measurement configuration in the measurement report.

Some embodiments herein may involve wireless communications according to one or more other wireless communication standards. Examples of other wireless communications technologies and/or standards that may be used in various embodiments may include—without limitation—other IEEE wireless communication standards such as the IEEE 802.11, IEEE 802.11a, IEEE 802.11b, IEEE 802.11g, IEEE 802.11n, IEEE 802.11u, IEEE 802.11ac, IEEE 802.11ad, IEEE 802.11af, IEEE 802.11 ah, IEEE 802.11ay, and/or other current of future IEEE 802.11 standards, Wi-Fi Alliance (WFA) wireless communication standards, such as, Wi-Fi, Wi-Fi Direct, Wi-Fi Direct Services, Wireless Gigabit (WiGig), WiGig Display Extension (WDE), WiGig Bus Extension (WBE), WiGig Serial Extension (WSE) standards and/or standards developed by the WFA Neighbor Awareness Networking (NAN) Task Group, machine-type communications (MTC) standards such as those embodied in 3GPP Technical Report (TR) 23.887, 3GPP Technical Specification (TS) 22.368, and/or 3GPP TS 23.682, and/or near-field communication (NFC) standards such as standards developed by the NFC Forum, including any predecessors, revisions, progeny, and/or variants of any of the above.

Some embodiments may involve wireless communications performed according to one or more broadband wireless communication standards. For example, various embodiments may involve wireless communications performed according to one or more 3rd Generation Partnership Project (3GPP), 3GPP Long Term Evolution (LTE), and/or 3GPP LTE-Advanced (LTE-A) technologies and/or standards, including their predecessors, revisions, progeny, and/or variants. Additional examples of broadband wireless communication technologies/standards that may be utilized in some embodiments may include—without limitation—Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS), IEEE 802.16 wireless broadband standards such as IEEE 802.16m and/or IEEE 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1×RTT, CDMA2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their predecessors, revisions, progeny, and/or variants.

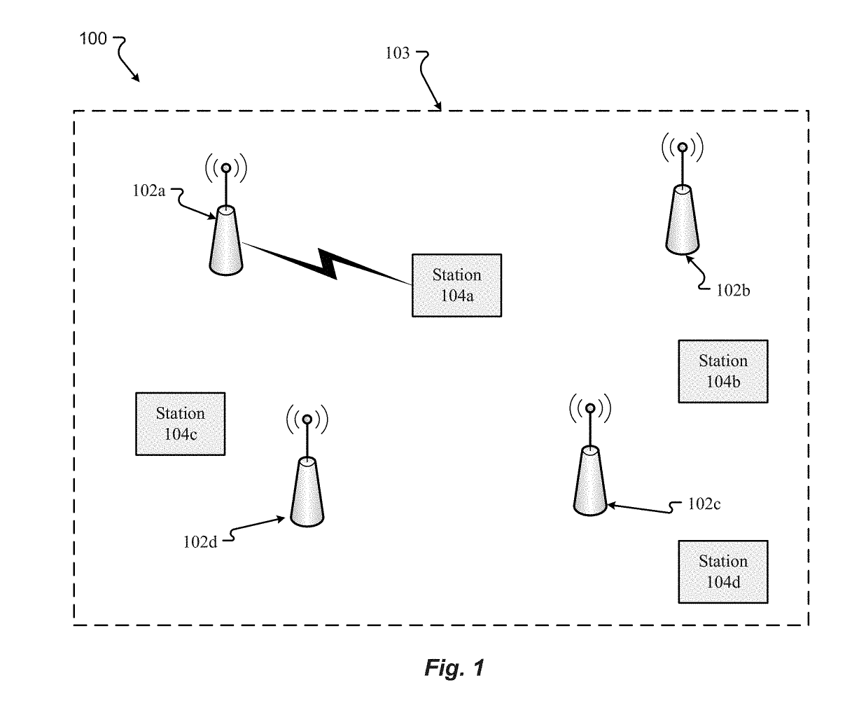

FIG. 1 illustrates an example of an operating environment 100 which may be representative of various configurations described herein. The WLAN 103 may comprise a personal basic service set (PBSS) that may include a master station 102 and one or more other stations STAs 104. For explanation purposes, herein, the master station 102 can function as the requesting STA (i.e., may function as a PCP/AP), while another STA 104a is the responding STA (however, in some configurations, these roles may be reversed or other APs 102b-102d or other STAs 104b-104d may function as either the requesting or responding STA).

The master station 102 may be an AP using the IEEE 802.11, protocols to transmit and receive. Hereinafter, the term AP will be used to identify the master station 102. The AP 102 may be a base station and may use other communications protocols as well as the IEEE 802.11 protocol. The IEEE 802.11 protocol may be the IEEE 802.11ax or later standard. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). The AP 102 may decide whether to allow spatial sharing and may configure the PBSS for spatial sharing.

The STAs 104a-104d may include one or more high-efficiency wireless (HEW) (as illustrated in, e.g., the IEEE 802.11ax standard). In other configurations, one or more of the STAs 104a-104d may be legacy STAs (as illustrated in, e.g., the IEEE 802.11n/ac standards). For example, the legacy STAs 104c may operate in accordance with one or more of IEEE 802.11 a/b/g/n/ac/ad/af/ah/aj, or another legacy wireless communication standard. The HEW STAs 104 a, b, d may be wireless transmit and receive devices, for example, a cellular telephone, a smart telephone, a handheld wireless device, wireless glasses, a wireless watch, a wireless personal device, a tablet, or another device that may be transmitting and receiving using a IEEE 802.11 protocol, for example, the IEEE 802.11ax or another wireless protocol. In the operating environment 100, an AP 102 may generally manage access to the wireless medium in the WLAN 103.

Within the environment 100, one or more STAs 104a, 104b, 104c, 104d may associate and/or communication with the AP 102 to join the WLAN 103. Joining the WLAN 103 may enable STAs 104a-104d to wirelessly communicate with each other via the AP 102, with each other directly, with the AP 102, or to another network or resource through the AP 102. In some configurations, to send data to a recipient (e.g., STA 104a), a sending STA (e.g., STA 104b) may transmit an uplink (UL) physical layer convergence procedure (PLCP) protocol data unit (PPDU) comprising the data to AP 102, which may then send the data to the recipient STA 104a, in a downlink (DL) PPDU.

In some configurations, a frame of data transmitted between the STAs 104 or between a STA 104 and the AP 102 may be configurable. For example, a channel used in for communication may be divided into subchannels that may be 20 MHz, 40 MHz, or 80 MHz, 160 MHz, 320 MHz of contiguous bandwidth or an 80+80 MHz (160 MHz) of non-contiguous bandwidth. Further, the bandwidth of a subchannel may be incremented into 1 MHz, 1.25 MHz, 2.03 MHz, 2.5 MHz, 5 MHz and 10 MHz bandwidths, or a combination thereof, or another bandwidth division that is less or equal to the available bandwidth may also be used. The bandwidth of the subchannels may be based on a number of active subcarriers. The bandwidth of the subchannels can be multiples of 26 (e.g., 26, 52, 104, etc.) active subcarriers or tones that are spaced by 20 MHz. In some configurations, the bandwidth of the subchannels is 256 tones spaced by 20 MHz. In other configurations, the subchannels are a multiple of 26 tones or a multiple of 20 MHz. A 20 MHz subchannel may also comprise 256 tones for use with a 256 point Fast Fourier Transform (FFT).

At a given point in time, multiple STAs 104a-d, in the WLAN 103, may wish to send data. In some configurations, rather than scheduling medium access for STAs 104a-d in different respective UL time intervals, the AP 102 may schedule medium access for STAs 104a-d to support UL multi-user (MU) transmission techniques, according to which multiple STAs 104a-d may transmit UL MU PPDUs to the AP 102 simultaneously during a given UL time interval. For example, by using UL MU OFDMA techniques during a given UL time interval, multiple STAs 104a-d may transmit UL MU PPDUs to AP 102 via different respective OFDMA resource units (RUs) allocated by AP 102. In another example, by using UL MU multiple-input multiple-output (MU-MIMO) techniques during a given UL time interval, multiple STAs 104a-d may transmit UL MU PPDUs to the AP 102 via different respective spatial streams allocated by the AP 102.

To manage access, the AP 102 may transmit a HEW master-sync transmission, which may be a trigger frame (TF) or a control and schedule transmission, at the beginning of the control period. The AP 102 may transmit a time duration of the transmit opportunity (TxOP) and sub-channel information. During the HEW control period, HEW STAs 104 a, b, d may communicate with the AP 102 in accordance with a non-contention based multiple access technique such as OFDMA or MU-MIMO. This HEW technique is unlike conventional WLAN communications in which devices communicate in accordance with a contention-based communication technique, rather than a multiple access technique. During the HEW control period, the AP 102 may communicate with stations 104 using one or more control frames, and the STAs 104 may operate on a sub-channel smaller than the operating range of the AP 102. Also, during the control period, legacy stations may refrain from communicating by entering a deferral period.

During the HEW master-sync transmission, the STAs 104 may contend for the wireless medium with the legacy devices 106 being excluded from contending for the wireless medium during the HEW master-sync transmission. The trigger frame used during this HEW master-sync transmission may indicate an UL-MU-MIMO and/or UL OFDMA control period. The multiple-access technique used during the control period may be a scheduled OFDMA technique, or alternatively, may be a TDMA technique, a frequency division multiple access (FDMA) technique, or a SDMA technique.

The AP 102 may also communicate with legacy stations and/or HEW stations 104 in accordance with legacy IEEE 802.11 communication techniques. In some configurations, the AP 102 may also be configurable to communicate with HEW stations 104 outside the HEW control period in accordance with legacy IEEE 802.11 communication techniques, although this is not a requirement.

PCP/AP 102a represents a requesting STA and STA 104a represents a responding STA for conducting measurement report exchange in the WLAN 103. The requesting STA 102a may desire measurement results and can send a measurement request to begin a procedure to obtain a measurement report. Any of the APs 102 may act as the requesting STA. For the purposes of explanation, PCP/AP 102a will be described as the requesting STA.

STA 104a can receive the measurement request and provide a measurement report. Any of the STAs 104b-104d may also function similarly to STA 104a, as explained herein, as the responding STA. For ease of explanation, the multiple requests and responses used to obtain measurement reports to determine spatial sharing are not shown, but one exchange that could be repeated for the other STAs 104b-104d is provided herein.

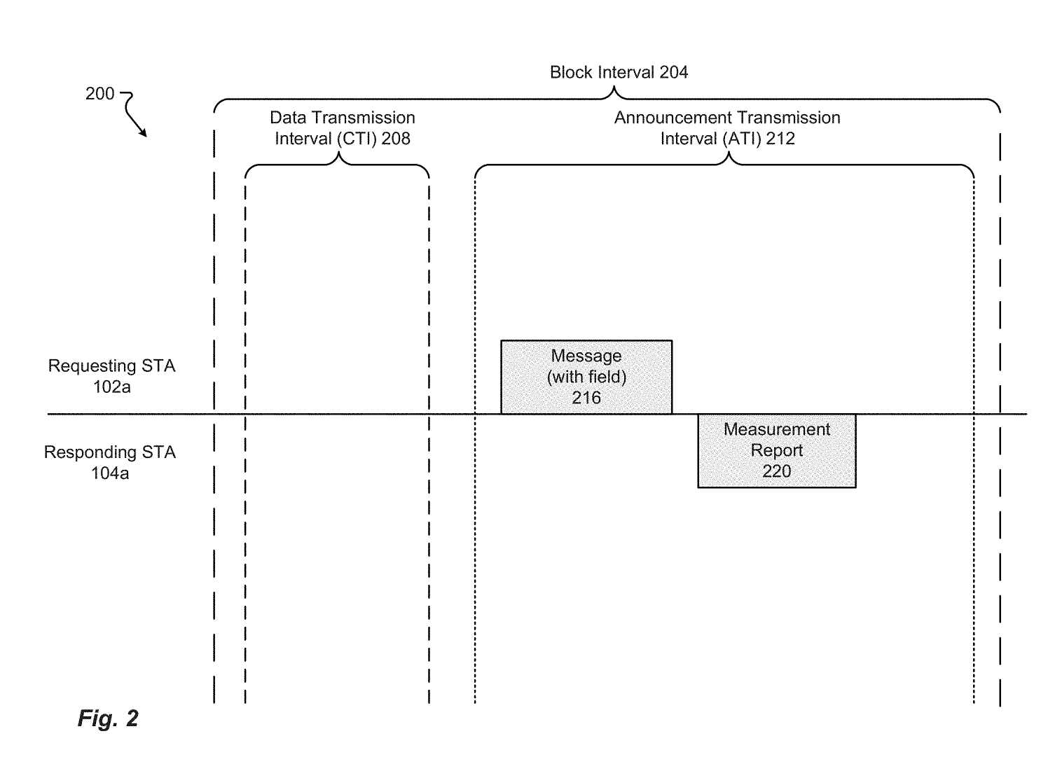

FIG. 2 illustrates the signalling process for the measurement reporting procedure. In the simplified example in FIG. 2, STA 104a is the responding STA and PCP/AP 102a is the requesting STA. The two STAs perform the measurement reporting procedure described. The measurements taken during a measurement process can include interference measurements, which can include Received Signal Strength Indicator (RSSI), dropped packet estimation, etc.

All the measurement information can be placed in a measurement report sent from the responding STA 104a to the requesting STA 102a. Obtaining the measurement report in a timely manner is important to allow spatial sharing during certain transmission periods. Without obtaining the measurement reports timely can preclude spatial sharing, which limits the bandwidth of the PBSS.

As shown in FIG. 2, one division of communication in the WLAN 103 is the Block Interval (BI) 204. The BI 204 represents a period for transmission time that may be based on a size of a block used to transmit wirelessly data to/from STAs. The BI 204 can be set by one or more control information sent in one or more data packets, beacons, etc. Herein, the BI 204 can be composed of at least a data transmission interval (DTI) 208 and an announcement transmission interval (ATI) 212. The DTI 208 may be used to exchange information between STAs 102, 104. The ATI 212 may be used for control information or other announcements. Generally, the DTI 208 have a longer period than the ATI 212. Thus, transmissions in the ATI 212 need to be optimized to ensure the ATI 212 does not subsume transmission time better spent on data transmission in the DTI 208. Further, the ATI 212 has specific rules that preclude communications by certain STAs (e.g., 104) without receiving a request from another STA (e.g., 102a). This limitation ensures that the ATI 212 is not inundated with numerous communications from various STAs 104, 102. It should be noted that the BI 204 is shown as only including the DTI 208 and ATI 212. However, more intervals may be including on or with the BI 204 (e.g., the beacon transmission interval (VTI), the beamforming training (A-BFT), etc.) These other intervals are excluded to simplify the description herein.

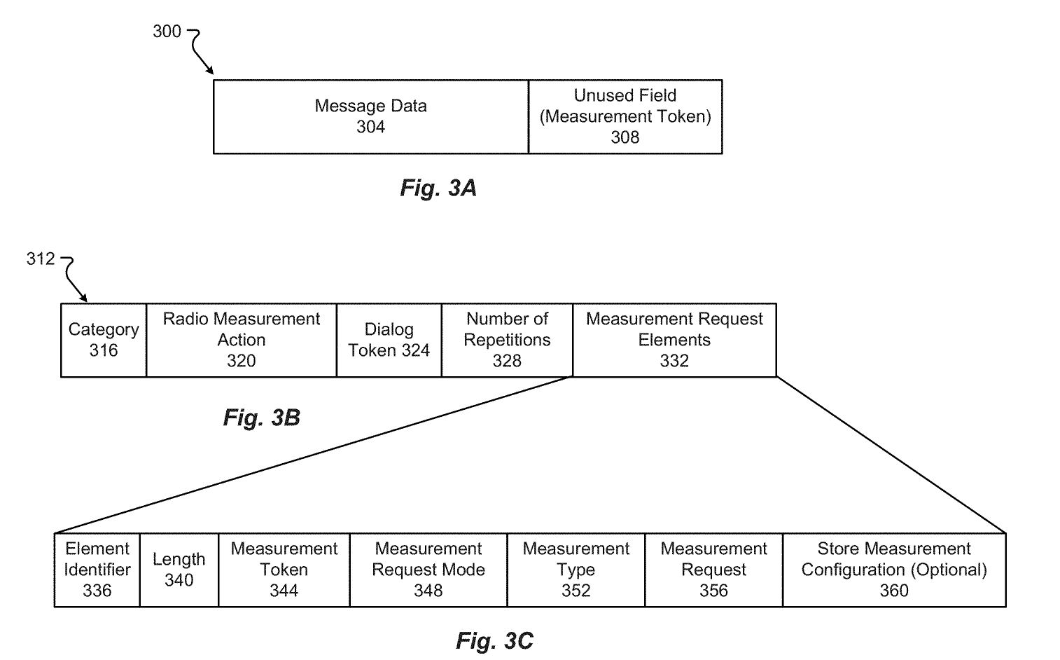

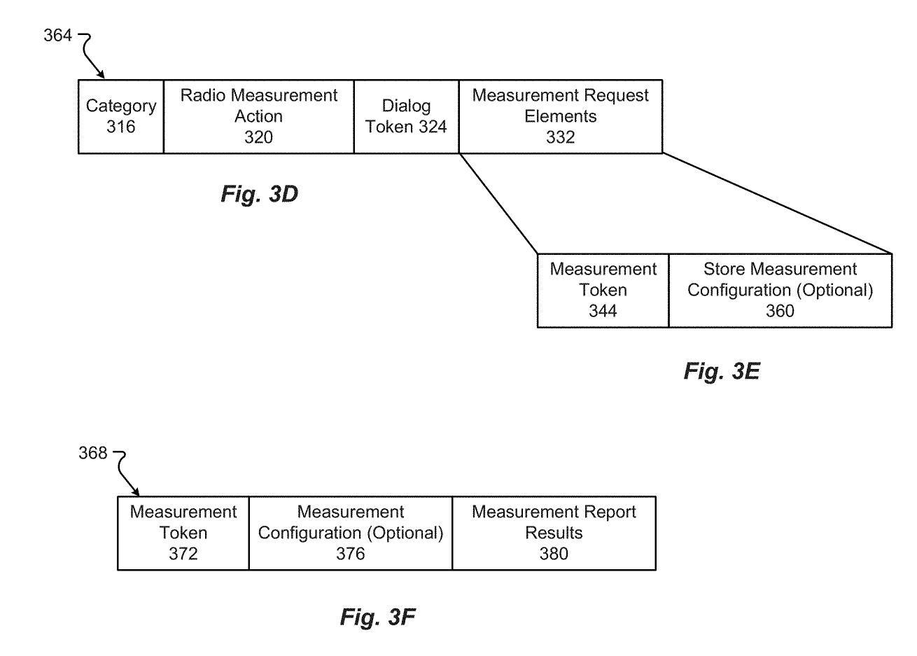

In embodiments, the requesting STA 102a may send a measurement request signal 216 to the responding STA 104a during the ATI 212. The measurement request signal 212 may be received by the responding STA 104a during the ATI 212. An example of the measurement request signal 216 can include a measurement request 300, 312, 364, which may be described in conjunction with one of FIGS. 3A, 3B, 3C, 3D, and/or 3E.

In response to receiving the measurement request 216, the responding STA 104a and, optionally, the additional responding STAs 104b-104d can send a measurement report 220 to the requesting STA 102a. The requesting STA 102a can receive the measurement report 220. The measurement report signal 220 can include a measurement report 368 as described in conjunction with FIG. 3E. The measurement report 220, if available, must be sent by the responding STA 104a during the ATI 212. As such, the unpredictability of the STAs is minimized. If no response is received, the requesting STA 102a can assume that the STA 104a had no measurement report 220 to provide to the requesting STA 102a.

The responding STA 104a may determine the ability to allow for spatial sharing based on the data included in the measurement report(s) 220. The PCP/AP 102a may then authorize and/or configure the PBSS for spatial sharing in a subsequent transmission

FIGS. 3A, 3B, 3C, 3D, and/or 3E include data structures sent, received, and/or stored as the measurement request described herein. The embodiments presented in this disclosure suggest improving the overhead burden for requesting measurement reports and/or for sending the measurement reports during the ATI 212.

A first message 300 may be any message that is already sent during the ATI 212, excluding a measurement request (shown in FIGS. 3B-3E). A new field 308 is introduced in the first message 300, which is optional and could be added in any message. When the responding STA 104a receives the message with this new field 308 present, the responding STA 104a shall feedback measurement results. Thus, if the requesting STA 102a (the PCP/AP) sends a measurement request to a STA (the responding STA 104a) in the ATI 212, by default, the responding STA 104a shall report measurement result if the responding STA 104a has measurement results to be reported.

The message 300 can include message data 304, which includes any data required for the message 300. An unused field 308 can be a reserved field, an optional field, or a field that is seldom or not used by the message 300 or its ilk. This field 308 may be changed to contain a bit or bits data to request a measurement request 308. The measurement request can be a bit or bits indicating that the sender of the message 300 (the requesting STA 102a) desires the recipient (the responding STA 104a) to provide a measurement report. The bit or bits 308 replace what would normally be in the message. The message 300 can be an announcement message, a beacon, a different type of request message, etc.

In some configurations, the unused field 308 contains a measurement token. The measurement token can include data identifying a measurement event or measurement report desired by the requesting STA 102a. Thus, the measurement token can include an identifier (e.g., a numeric identifier, alphanumeric identifier, globally-unique identifier (GUID), etc.) that identifies a measurement report.

In contrast to the message 300, a measurement request message 312 and/or 364 are shown in FIGS. 3B and 3D. The data structure 312 can include typical measurement request message fields, including one or more of, but not limited to: a category field 316, a radio measurement action field 320, a dialog token 324, a number of repetitions field 328, and/or measurement request elements 332. A category 304 can define what type of content is in the message 300 (i.e., that the message 300 is a measurement request). The radio measurement action field 320 can indicate that the message is meant as a request for measurement results or an indication the responding STA 104a should conduct measurements. Further, the radio measurement action field 320 can indicate to the responding STA 104a how the measurements are to be made (general measurement configuration information). The dialog token 312 can be an identifier for a specific message exchange between STAs 102, 104.

The number of repetitions field 328 can indicate how many interactions the measurements should be made and/or the number of times the responding STA 104a should attempt to send the measurement results, if one or more transmission attempts are unsuccessful. The measurement request elements 332 provide a set of data, provided in FIG. 3C, that indicate parameters for the measurement activity or what information should be included in the measurement report.

The measurement request elements 332 can include one or more of, but not limited to: an element identifier 336, a length 340, a measurement token 344, a measurement request mode 348, a measurement type 352, a measurement request 356, and/or an optional store measurement configuration indicator 360. The element identifier 336 can indicate which element or elements are involved in the measurements. The length 340 can provide for a length of the measurement activity or the length of the measurement report to be provided. A measurement token 344 provides an identifier for the particular measurement event. Each time a measurement is made or ordered, a new measurement token 344 is created. As such, the STAs 102, 104 can identify which measurement reports are associated with which measurement requests.

A measurement request mode 348 can indicate the how or what type of measurement request is being made. The measurement type 352 can indicate what type of measurement is to be performed. The measurement request 356 can indicate whether a new measurement is to be made.

The optional store measurement configuration field 360 can provide an indicator to the responding STA 104a whether the requesting STA 102a has or will store the configurations settings (provided in fields 336-356). If the configuration settings are stored, the responding STA 104a may not need to send those settings in the measurement report. By setting a bit or bits in the store measurement configuration field 360, the requesting STA 102a will indicate that the requesting STA 102a will store the measurement configuration. If, the requesting STA 102a chooses not to include the measurement configuration in the Measurement Report, the overhead for sending the measurement report improves. If it is assumed that the overhead is determined by comparing the ATI length (in u seconds), ATI length can be decreased by approximately 13% when the number of STAs is 10 and the number of measurement elements is 8. Eliminating the reporting of measurement configuration information in a WLAN 103 with a higher number of STAs 104, 102 and/or a higher number of measurement elements can reap more benefits.

FIGS. 3D and 3E provide a different and better optimized measurement request message 364. Here, various fields are eliminated from the message 312 shown in FIGS. 3B and 3C. Namely, the data structure 364 can elimination one or more of, but not limited to: a number of repetitions field 328, an element identifier 336, a length 340, a measurement request mode 348, a measurement type 352, a measurement request 356, and/or an optional store measurement configuration indicator 360. Thus, only the measurement token 344 may remain in the measurement request elements 332 of message 364. In some configurations, the optional store measurement configuration indicator 360 is maintained to better optimize the measurement report. In some configurations, all the above fields (i.e., a number of repetitions field 328, an element identifier 336, a length 340, a measurement request mode 348, a measurement type 352, a measurement request 356, and/or an optional store measurement configuration indicator 360) are eliminated to provide a much smaller message.

Thus, new message 364 can remove all the measurement configuration information but keep the measurement token 344, which can be used to indicate what measurement report should be returned by the responding STA 104a. A simple calculation can be done to determine the amount of overhead that can be saved by using message 364. Assuming a Single Carrier (SC) with an MCS=1, and the overhead is determined by comparing the ATI length (in u seconds). The ATI length decreases by approximately 21% when number of STAs is 10 and the number of measurement elements is 8. Again, using message 364 in a WLAN 103 with a higher number of STAs and/or a higher number of measurement elements can reap more benefits.

An embodiment of a measurement report 368 is shown in FIG. 3F. The measurement report 368 can include typical fields, for example, the measurement token 368 and measurement report results 380, but may eliminate the measurement configuration 376 in some instances. The measurement token 372 can be the same or similar to the measurement token 344 described above and can associate the measurement report 368 to a measurement request 300, 312, 364. The measurement report results 380 can provide the results of a measurement event. The measurement configuration 376 can be the same or similar to the measurement configuration 376 described above. The measurement report 368 is different from the typical measurement report in that the measurement report 368 can eliminate the measurement configuration 376 from the message to reduce the size of the message.

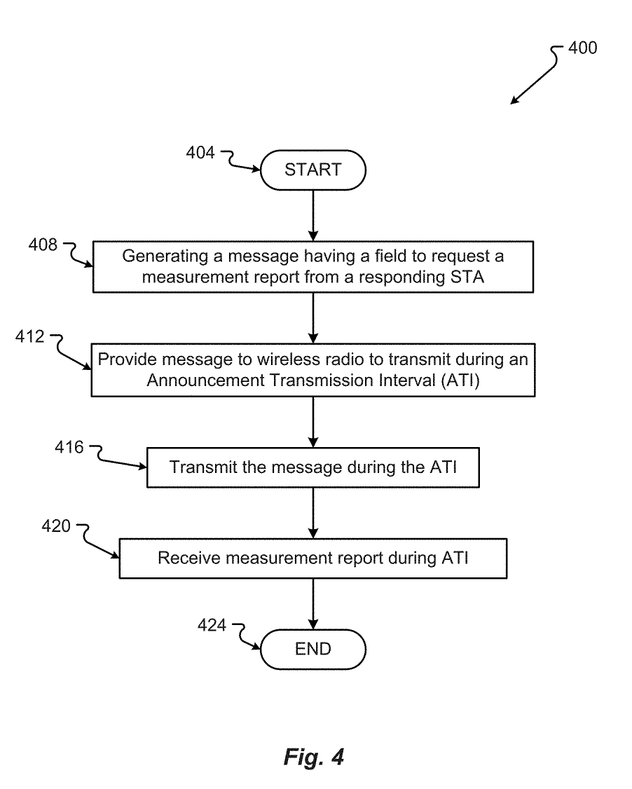

The method 400, conducted by a requesting STA 102a, for requesting a measurement report may be as shown in FIG. 4. A general order for the steps of the method 400 is shown in FIG. 4. Generally, the method 400 starts with a start operation 404 and ends with operation 424. The method 400 can include more or fewer steps or can arrange the order of the steps differently than those shown in FIG. 4. The method 400 can be executed as a set of computer-executable instructions executed by a computer system or processor and encoded or stored on a computer readable medium. In other configurations, the method 400 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 400 shall be explained with reference to the systems, components, circuits, modules, software, data structures, signalling processes, etc. described in conjunction with FIGS. 1-3F and 8.

The controller 820 of a requesting STA 102a may generate a measurement request 300, 312, or 364, in step 408. The measurement request 386 can, in some configurations, request the measurement report, from a responding STA 104a, in field 308. Optionally, the measurement request 312 may also request the measurement report. Alternatively, the measurement request 364 can make the request with a smaller message. Regardless of the type of message, the message is sent from the controller 820 to the RF component(s) (the radio frequency (RF) component(s) (e.g., the transmitter 888, the receiver 892, the MAC module 884, the PHY module 880, etc.) to be sent during the ATI 212. The RF component(s) of the requesting STA 102a may then send a measurement request signal 216, including the measurement request 300, 312, or 364, in step 416. The signal 216 is sent during the ATI 212.

If the responding STA 104a has a measurement report to send, the RF components will receive the measurement report signal 220 at some time thereinafter, during the ATI 212, in step 420. The RF components may then provide the measurement report 368, in the measurement report signal 220, to the controller 820 to determine if spatial sharing is possible.

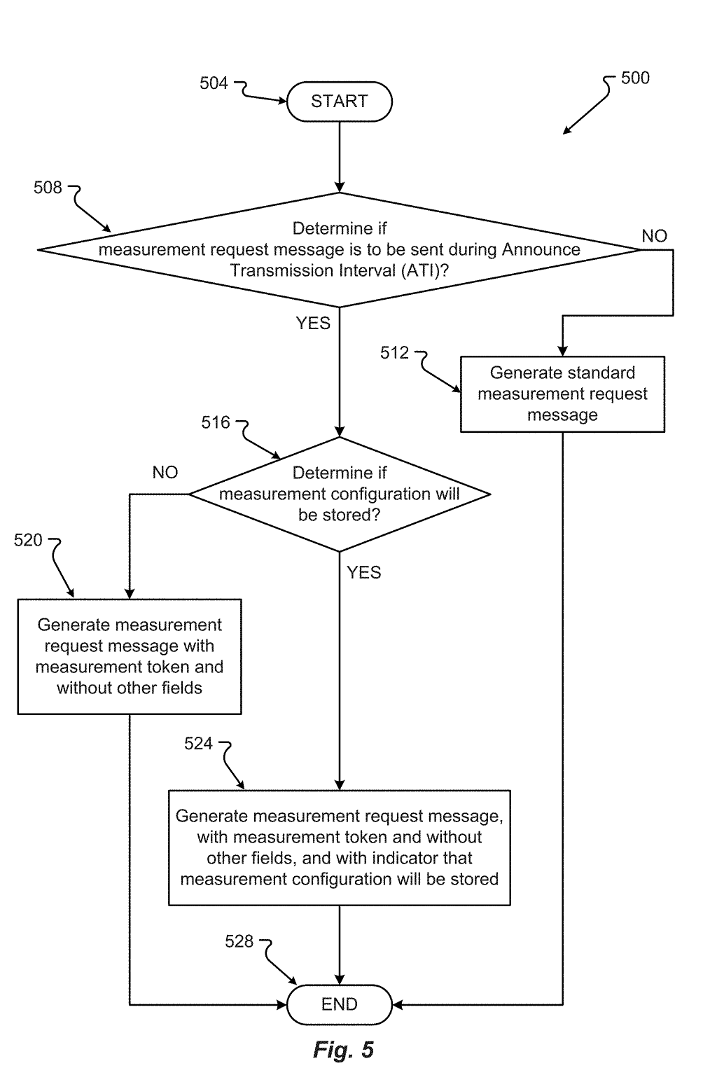

The process 500, conducted by the requesting STA 102a, for generating the message request may be as shown in FIG. 5. A general order for the steps of the method 500 is shown in FIG. 5. Generally, the method 500 starts with a start operation 504 and ends with operation 528. The method 500 can include more or fewer steps or can arrange the order of the steps differently than those shown in FIG. 5. The method 500 can be executed as a set of computer-executable instructions executed by a computer system or processor and encoded or stored on a computer readable medium. In other configurations, the method 500 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 500 shall be explained with reference to the systems, components, circuits, modules, software, data structures, signalling processes, etc. described in conjunction with FIGS. 1-4 and 8.

During or before generating or transmitting the message 216, in steps 408 and/or 416 above, the controller 820 of the requesting STA 102a may determine if the measurement request message 220 is to be sent during the ATI 212. The measurement request message 220 can be sent during the DTI 208. If the measurement request message 220 is not to be sent during the ATI 212, the method 500 can proceed “NO” to step 512, where the controller 820 can generate a more standard measurement request message, e.g., message 312, and send the signal 216 by the RF components (this signal 216 will be sent sometime other than during the ATI 212, unlike what is shown in FIG. 2).

If the measurement request message 220 is to be sent during the ATI 212, the method 500 can proceed “YES” to step 516. In step 516, the controller 820 can determine if the measurement configuration is to be stored in memory 816 for the measurement event and beyond. If the memory configuration is not to be saved, the controller 820 can generate a lower overhead measurement request message 364 without the optional “Store Measurement Configuration” field 360 set. If the measurement configuration is to be saved in memory 816, the controller 820 can generate a lower overhead measurement request message 364 with the optional “Store Measurement Configuration” field 360 set.

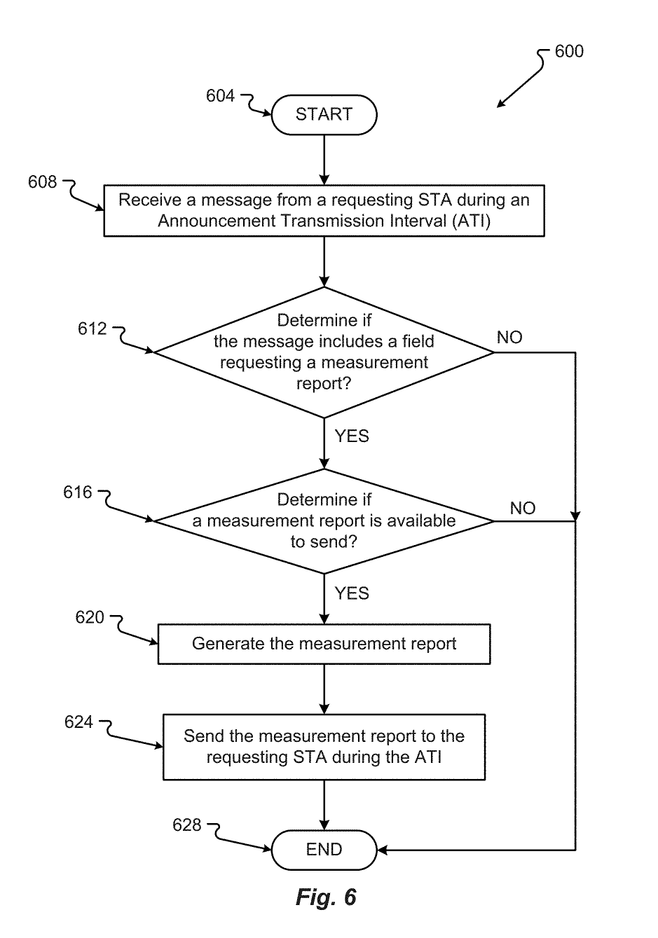

The process 600, conducted by the responding STA 104a, for sending a measurement report may be as shown in FIG. 6. A general order for the steps of the method 600 is shown in FIG. 6. Generally, the method 600 starts with a start operation 604 and ends with operation 628. The method 600 can include more or fewer steps or can arrange the order of the steps differently than those shown in FIG. 6. The method 600 can be executed as a set of computer-executable instructions executed by a computer system or processor and encoded or stored on a computer readable medium. In other configurations, the method 600 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 600 shall be explained with reference to the systems, components, circuits, modules, software, data structures, signalling processes, etc. described in conjunction with FIGS. 1-5 and 8.

The RF components may receive a measurement request signal 216, including the measurement request 300, 312, 364, during the ATI 212, in step 608. The measurement request 300, 312, 364 may then be passed to the controller 820. The controller 820 can determine if the field 308 is set requiring the responding STA 104a to send a measurement report 368 to the requesting STA 102a, during the ATI 212, in step 612. In another configuration, if a measurement token 344 is received in measurement request 312 or 364, the controller 820, of the responding STA 104a, can determine that a measurement report 368 is to be sent to the requesting STA 102a. If no measurement report is requested in step 612, the method 600 proceeds “NO” to end operation 628.

If a measurement report is requested in step 612, the method 600 proceeds “YES” to step 616, where the controller 820 can determine if a measurement report 368 is available to be sent. The controller 820 can search memory 816 for a measurement report 368 having a measurement token 372 that is the same or associated with measurement token 344 or associated with information in the field 308. In other configurations, the controller 820 attempts to locate any measurement report 368 stored in memory 816. The controller 820 may only send a measurement report 368 if it has been generated recently (within the current context when the device 104a gained access to the WLAN 103). Additionally or alternatively, the controller 820 may conduct another measurement and generate a new measurement report 368 to send. If the controller 820 finds or creates a measurement report 368 to send, the method 600 proceeds “YES” to step 620. If the controller 820 does not find or create a measurement report 368 to send, the method 600 proceeds “NO” to end operation 628.

The controller 820 can then generate the measurement report 368, in step 620. The measurement report 368 may then be incorporated into a signal 220, and the RF components can send the measurement report 368 back to the requesting STA 102a, in step 624, during the ATI 212.

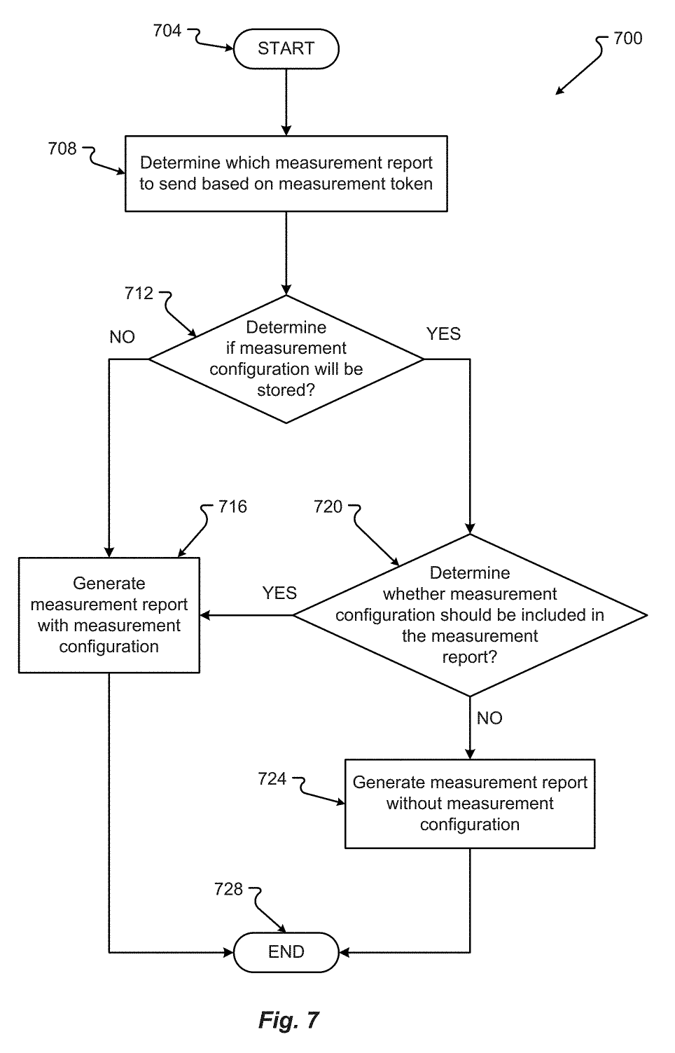

The process 700, conducted by the responding STA 104a, for sending a measurement report 368 may be as shown in FIG. 7. A general order for the steps of the method 700 is shown in FIG. 7. Generally, the method 700 starts with a start operation 707 and ends with operation 728. The method 700 can include more or fewer steps or can arrange the order of the steps differently than those shown in FIG. 7. The method 700 can be executed as a set of computer-executable instructions executed by a computer system or processor and encoded or stored on a computer readable medium. In other configurations, the method 700 may be executed by a series of components, circuits, gates, etc. created in a hardware device, such as a System of Chip (SOC), Application Specific Integrated Circuit (ASIC), and/or a Field Programmable Gate Array (FPGA). Hereinafter, the method 700 shall be explained with reference to the systems, components, circuits, modules, software, data structures, signalling processes, etc. described in conjunction with FIGS. 1-6 and 8.

The controller 820, in step 708, can determine which measurement report 368 to send based on information in the measurement token 344. The controller 820 can extract an identifier from the measurement token 344 and search the memory 816 for a measurement token 372 having the same identifier. If a measurement token 372 with the same identifier is located, the controller 820 can read the measurement report 368 from memory 816 to send back to the responding STA 104a. Before generating the measurement report 368 in step 620, the controller 820 can determine if the measurement configuration will be or has been stored by the responding STA 104a. The controller 820 can determine if the bit or bits in the store measurement configuration field 360 is set. If the measurement configuration will be or has been stored by the responding STA 104a, the method 600 proceeds “YES” to step 720. If the measurement configuration will not be or has not been stored by the responding STA 104a, the method 600 proceeds “NO” to step 716, where the controller 820 generates a measurement report 368 including the measurement configuration 376.

In step 720, the controller 820 determines if the measurement configuration 376 should be included in the measurement report 368. If bandwidth or overhead in the ATI 212 are problematic or would make the ATI 212 too long in duration, the controller 820 may exclude the measurement configuration 376. In contrast, if there would be no adverse effect, the controller 820 may include the measurement configuration 376. If the measurement configuration 376 is to be included in the measurement report 368, the method 700 can proceed “YES” to step 716, as previously described. If the measurement configuration 376 is not to be included in the measurement report 368, the method 700 can proceed “NO” to step 724, where the controller 820 can generate the measurement report 368 without the measurement configuration 376 in the measurement report 368.

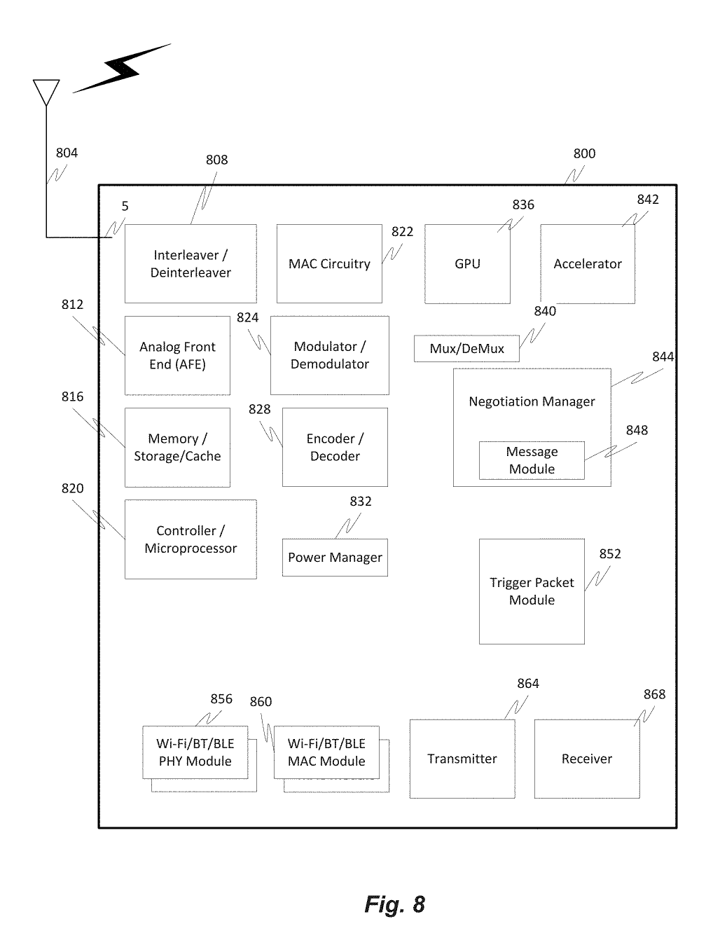

FIG. 8 illustrates an exemplary hardware diagram of a device 800, such as a wireless device, mobile device, access point, station, and/or the like, that is adapted to implement the technique(s) discussed herein. Operation will be discussed in relation to the components in FIG. 8 appreciating that each separate device in a system, e.g., station, AP, proxy server, etc., can include one or more of the components shown in the figure, with the components each being optional.

In addition to well-known componentry (which has been omitted for clarity), the device 800 includes interconnected elements (with links 5 omitted for clarity) including one or more of: one or more antennas 804, an interleaver/deinterleaver 808, an analog front end (AFE) 812, memory/storage/cache 816, controller/microprocessor 820, MAC circuitry 822, modulator/demodulator 824, encoder/decoder 828, power manager 832, GPU 836, accelerator 842, a multiplexer/demultiplexer 840, a negotiation manager 844, message module 848, trigger packet module 852, and wireless radio components such as a Wi-Fi/BT/BLE PHY module 856, a Wi-Fi/BT/BLE MAC module 860, transmitter 864 and receiver 868. The various elements in the device 800 are connected by one or more links (not shown, again for sake of clarity). As one example, the negotiation manager 844 and message module 848 can be embodied as a process executing on a processor or controller, such as processor 820 with the cooperation of the memory 816. The negotiation manager 844 and message module 848 could also be embodied as an ASIC and/or as part of a system on a chip. In some configurations, there can be multiple instances of the PHY Module/Circuitry 856, MAC circuitry 822, transmitter 864, and/or receiver 868, wherein each instance of the PHY Module/Circuitry 856, MAC circuitry 822, transmitter 864, and/or receiver 868 sends/receives data over a specific band (e.g., 2.45 GHz, 915 MHz, 5.2 GHz, etc.) to facilitate multi-band transmissions.

The device 800 can have one more antennas 804, for use in wireless communications such as multi-input multi-output (MIMO) communications, multi-user multi-input multi-output (MU-MIMO) communications Bluetooth®, LTE, RFID, 4G, LTE, etc. The antenna(s) 804 can include, but are not limited to one or more of directional antennas, omnidirectional antennas, monopoles, patch antennas, loop antennas, microstrip antennas, dipoles, and any other antenna(s) suitable for communication transmission/reception. In an exemplary embodiment, transmission/reception using MIMO may require particular antenna spacing. In another exemplary embodiment, MIMO transmission/reception can enable spatial diversity allowing for different channel characteristics at each of the antennas. In yet another embodiment, MIMO transmission/reception can be used to distribute resources to multiple users.

Antenna(s) 804 generally interact with the Analog Front End (AFE) 812, which is needed to enable the correct processing of the received modulated signal and signal conditioning for a transmitted signal. The AFE 812 can be functionally located between the antenna and a digital baseband system to convert the analog signal into a digital signal for processing and vice-versa.

The device 800 can also include a controller/microprocessor 820 and a memory/storage/cache 816. The device 800 can interact with the memory/storage/cache 816 which may store information and operations necessary for configuring and transmitting or receiving the information described herein. The memory/storage/cache 816 may also be used in connection with the execution of application programming or instructions by the controller/microprocessor 820, and for temporary or long term storage of program instructions and/or data. As examples, the memory/storage/cache 820 may comprise a computer-readable device, RAM, ROM, DRAM, SDRAM, and/or other storage device(s) and media.

The controller/microprocessor 820 may comprise a general purpose programmable processor or controller for executing application programming or instructions related to the device 800. Furthermore, the controller/microprocessor 820 can perform operations for configuring and transmitting information as described herein. The controller/microprocessor 820 may include multiple processor cores, and/or implement multiple virtual processors. Optionally, the controller/microprocessor 820 may include multiple physical processors. By way of example, the controller/microprocessor 820 may comprise a specially configured Application Specific Integrated Circuit (ASIC) or other integrated circuit, a digital signal processor(s), a controller, a hardwired electronic or logic circuit, a programmable logic device or gate array, a special purpose computer, or the like.

The device 800 can further include a transmitter 864 and receiver 868 which can transmit and receive signals, respectively, to and from other wireless devices and/or access points using the one or more antennas 804. Included in the device 800 circuitry is the medium access control or MAC Circuitry 822. MAC circuitry 822 provides for controlling access to the wireless medium. In an exemplary embodiment, the MAC circuitry 822 may be arranged to contend for the wireless medium and configure frames or packets for communicating over the wireless medium.

The PHY Module/Circuitry 856 controls the electrical and physical specifications for device 800. In particular, PHY Module/Circuitry 856 manages the relationship between the device 800 and a transmission medium. Primary functions and services performed by the physical layer, and in particular the PHY Module/Circuitry 856, include the establishment and termination of a connection to a communications medium, and participation in the various process and technologies where communication resources shared between, for example, among multiple STAs. These technologies further include, for example, contention resolution and flow control and modulation or conversion between a representation digital data in user equipment and the corresponding signals transmitted over the communications channel. These are signals are transmitted over the physical cabling (such as copper and optical fiber) and/or over a radio communications (wireless) link. The physical layer of the OSI model and the PHY Module/Circuitry 856 can be embodied as a plurality of sub components. These sub components or circuits can include a Physical Layer Convergence Procedure (PLCP) which acts as an adaption layer. The PLCP is at least responsible for the Clear Channel Assessment (CCA) and building packets for different physical layer technologies. The Physical Medium Dependent (PMD) layer specifies modulation and coding techniques used by the device and a PHY management layer manages channel tuning and the like. A station management sub layer and the MAC circuitry 822 handle co-ordination of interactions between the MAC and PHY layers.

The interleaver/deinterleaver 808 cooperates with the various PHY components to provide Forward Error correction capabilities. The modulator/demodulator 824 similarly cooperates with the various PHY components to perform modulation which in general is a process of varying one or more properties of a periodic waveform, referred to and known as a carrier signal, with a modulating signal that typically contains information for transmission. The encoder/decoder 828 manages the encoding/decoding used with the various transmission and reception elements in device 800.

The MAC layer and components, and in particular the MAC module 860 and MAC circuitry 822 provide functional and procedural means to transfer data between network entities and to detect and possibly correct errors that may occur in the physical layer. The MAC module 860 and MAC circuitry 822 also provide access to contention-based and contention-free traffic on different types of physical layers, such as when multiple communications technologies are incorporated into the device 800. In the MAC layer, the responsibilities are divided into the MAC sub-layer and the MAC management sub-layer. The MAC sub-layer defines access mechanisms and packet formats while the MAC management sub-layer defines power management, security and roaming services, etc.

The device 800 can also optionally contain a security module (not shown). This security module can contain information regarding but not limited to, security parameters required to connect the device to an access point or other device or other available network(s), and can include WEP or WPA/WPA-2 (optionally+AES and/or TKIP) security access keys, network keys, etc. The WEP security access key is a security password used by Wi-Fi networks. Knowledge of this code can enable a wireless device to exchange information with the access point and/or another device. The information exchange can occur through encoded messages with the WEP access code often being chosen by the network administrator. WPA is an added security standard that is also used in conjunction with network connectivity with stronger encryption than WEP.

The accelerator 842 can cooperate with MAC circuitry 822 to, for example, perform real-time MAC functions. The GPU 836 can be a specialized electronic circuit designed to rapidly manipulate and alter memory to accelerate the creation of data such as images in a frame buffer. GPUs are typically used in embedded systems, mobile phones, personal computers, workstations, and game consoles. GPUs are very efficient at manipulating computer graphics and image processing, and their highly parallel structure makes them more efficient than general-purpose CPUs for algorithms where the processing of large blocks of data is done in parallel.

In the detailed description, numerous specific details are set forth in order to provide a thorough understanding of the disclosed techniques. However, it will be understood by those skilled in the art that the present techniques may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analysing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like. For example, “a plurality of stations” may include two or more stations.

It may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, circuitry, firmware or software, or some combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments are described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, within a Domain Master, and/or the Internet, or within a dedicated secured, unsecured, and/or encrypted system and/or within a network operation or management device that is located inside or outside the network. As an example, a Domain Master can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a network operation or management device, a node or collocated on a particular node of a distributed network, such as a communications network. As will be appreciated from the following description, and for reasons of computational efficiency, the components of the system can be arranged at any location within a distributed network without affecting the operation thereof. For example, the various components can be located in a Domain Master, a node, a domain management device, such as a MIB, a network operation or management device, a transceiver(s), a station, an access point(s), or some combination thereof. Similarly, one or more of the functional portions of the system could be distributed between a transceiver and an associated computing device/system.

Furthermore, it should be appreciated that the various links, including the communications channel(s) connecting the elements, can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operational or protocol.

Moreover, while some of the exemplary embodiments described herein are directed toward a transmitter portion of a transceiver performing certain functions, or a receiver portion of a transceiver performing certain functions, this disclosure is intended to include corresponding and complementary transmitter-side or receiver-side functionality, respectively, in both the same transceiver and/or another transceiver(s), and vice versa.

The exemplary embodiments are described in relation to enhanced GFDM communications. However, it should be appreciated, that in general, the systems and methods herein will work equally well for any type of communication system in any environment utilizing any one or more protocols including wired communications, wireless communications, powerline communications, coaxial cable communications, fiber optic communications, and the like.

The exemplary systems and methods are described in relation to IEEE 802.11 and/or Bluetooth® and/or Bluetooth® Low Energy transceivers and associated communication hardware, software and communication channels. However, to avoid unnecessarily obscuring the present disclosure, the following description omits well-known structures and devices that may be shown in block diagram form or otherwise summarized.

Exemplary aspects are directed toward:

A wireless communications device comprising: a controller to: generate a message with a field, wherein data within the field indicates that the wireless communications device is requesting a measurement report from a receiving station (STA); provide the message for transmission during an announcement transmission interval (ATI); receiving the measurement report; a wireless radio to: transmit the message, during the ATI, to the responding STA; in response to the data within the field, receive the measurement report; and provide the measurement report to the controller.

Any of the one or more above aspects, wherein the field uses an unused parameter in an existing message sent during the ATI.

Any of the one or more above aspects, wherein the responding STA is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the responding STA.

Any of the one or more above aspects, wherein the field includes an indicator as to whether the wireless communication device, requesting the measurement report, will store the measurement configuration.

Any of the one or more above aspects, wherein, based on the indicator, the responding STA determines whether to include the measurement configuration in the measurement report, and wherein the measurement report does not include the measurement configuration.

A method comprising: generating a message with a field, wherein data within the field indicates that the wireless communications device is requesting a measurement report from a receiving station (STA); providing the message for transmission during an announcement transmission interval (ATI); transmitting the message, during the ATI, to the responding STA; in response to the data within the field, receiving the measurement report; and providing the measurement report to a controller.

Any of the one or more above aspects, wherein the field uses an unused parameter in an existing message sent during the ATI.

Any of the one or more above aspects, wherein the responding STA is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the responding STA.

Any of the one or more above aspects, wherein the field includes an indicator as to whether the wireless communication device, requesting the measurement report, will store the measurement configuration.

Any of the one or more above aspects, wherein, based on the indicator, the responding STA determines whether to include the measurement configuration in the measurement report, and wherein the measurement report does not include the measurement configuration.

A non-transitory information storage media having stored thereon one or more instructions, that when executed by one or more processors, cause a wireless communications device to perform a method, the method comprising:

generating a message with a field, wherein data within the field indicates that the wireless communications device is requesting a measurement report from a receiving station (STA); providing the message for transmission during an announcement transmission interval (ATI); transmitting the message, during the ATI, to the responding STA; in response to the data within the field, receiving the measurement report; and providing the measurement report to a controller.

Any of the one or more above aspects, wherein the field uses an unused parameter in an existing message sent during the ATI.

Any of the one or more above aspects, wherein the responding STA is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the responding STA.

Any of the one or more above aspects, wherein the field includes an indicator as to whether the wireless communication device, requesting the measurement report, will store the measurement configuration.

Any of the one or more above aspects, wherein, based on the indicator, the responding STA determines whether to include the measurement configuration in the measurement report, and wherein the measurement report does not include the measurement configuration.

A wireless communications device comprising: means for generating a message with a field, wherein data within the field indicates that the wireless communications device is requesting a measurement report from a receiving station; means for providing the message for transmission during an announcement transmission interval (ATI); means for transmitting the message, during the ATI, to the responding STA; in response to the data within the field, means for receiving the measurement report; and means for providing the measurement report to a controller.

Any of the one or more above aspects, wherein the field uses an unused parameter in an existing message sent during the ATI.

Any of the one or more above aspects, wherein the responding STA is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the responding STA.

Any of the one or more above aspects, wherein the field includes an indicator as to whether the wireless communication device, requesting the measurement report, will store the measurement configuration.

Any of the one or more above aspects, wherein, based on the indicator, the responding STA determines whether to include the measurement configuration in the measurement report, and wherein the measurement report does not include the measurement configuration.

A wireless communications device comprising: a controller to: receive a message for during an announcement transmission interval (ATI); determine that the message includes a field, wherein data within the field indicates that the wireless communications device is required to send a measurement report to a requesting station (STA); in response to the data within the field, generate the measurement report; provide the measurement report; a wireless radio to: provide the message to the controller; receive the measurement report; and transmit the measurement report, during the ATI, to the requesting STA.

Any of the one or more above aspects, wherein the field uses an unused parameter in an existing message sent during the ATI.

Any of the one or more above aspects, wherein the wireless communications device is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the wireless communications device.

Any of the one or more above aspects, wherein the field includes an indicator as to whether the requesting STA will store the measurement configuration.

Any of the one or more above aspects, wherein, based on the indicator, the controller determines whether to include the measurement configuration in the measurement report, and wherein the measurement report does not include the measurement configuration.

A method comprising: receiving a message for during an announcement transmission interval (ATI); determining that the message includes a field, wherein data within the field indicates that the wireless communications device is required to send a measurement report to a requesting station (STA); in response to the data within the field, generating the measurement report; and transmitting the measurement report, during the ATI, to the requesting STA.

Any of the one or more above aspects, wherein the field uses an unused parameter in an existing message sent during the ATI.

Any of the one or more above aspects, wherein the wireless communications device is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the wireless communications device.

Any of the one or more above aspects, wherein the field includes an indicator as to whether the requesting STA will store the measurement configuration.

Any of the one or more above aspects, wherein, based on the indicator, the controller determines whether to include the measurement configuration in the measurement report, and wherein the measurement report does not include the measurement configuration.

A non-transitory information storage media having stored thereon one or more instructions, that when executed by one or more processors, cause a wireless communications device to perform a method, the method comprising: receiving a message for during an announcement transmission interval (ATI); determining that the message includes a field, wherein data within the field indicates that the wireless communications device is required to send a measurement report to a requesting station (STA); in response to the data within the field, generating the measurement report; and transmitting the measurement report, during the ATI, to the requesting STA.

Any of the one or more above aspects, wherein the field uses an unused parameter in an existing message sent during the ATI.

Any of the one or more above aspects, wherein the wireless communications device is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the wireless communications device.

Any of the one or more above aspects, wherein the field includes an indicator as to whether the requesting STA will store the measurement configuration.

Any of the one or more above aspects, wherein, based on the indicator, the controller determines whether to include the measurement configuration in the measurement report, and wherein the measurement report does not include the measurement configuration.

A wireless communications device comprising: means for receiving a message for during an announcement transmission interval (ATI); means for determining that the message includes a field, wherein data within the field indicates that the wireless communications device is required to send a measurement report to a requesting station (STA); in response to the data within the field, means for generating the measurement report; and means for transmitting the measurement report, during the ATI, to the requesting STA.

Any of the one or more above aspects, wherein the field uses an unused parameter in an existing message sent during the ATI.

Any of the one or more above aspects, wherein the wireless communications device is forced to send the measurement report, during the ATI, in response to the receiving the field.

Any of the one or more above aspects, wherein the message is not a measurement request message.

Any of the one or more above aspects, wherein the message is an announcement message.

Any of the one or more above aspects, wherein the message is a measurement request message, wherein the field is a measurement token, and wherein the measurement request message does not include at least one of a number of repetitions, an element identifier, a length field, a measurement request mode, a measurement type, or a measurement request field.

Any of the one or more above aspects, wherein the measurement request message does not include any of a number of repetitions, an element identifier, a length field, a measurement request mode, a measurement type, or a measurement request field.

Any of the one or more above aspects, wherein the measurement token indicates which measurement report should be sent by the wireless communications device.

Any of the one or more above aspects, wherein the field includes an indicator as to whether the requesting STA will store the measurement configuration.

Any of the one or more above aspects, wherein, based on the indicator, the controller determines whether to include the measurement configuration in the measurement report, and wherein the measurement report does not include the measurement configuration.

A system on a chip (SoC) including any one or more of the above aspects.

One or more means for performing any one or more of the above aspects.

Any one or more of the aspects as substantially described herein.

For purposes of explanation, numerous details are set forth in order to provide a thorough understanding of the present embodiments. It should be appreciated however that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The term transceiver as used herein can refer to any device that comprises hardware, software, circuitry, firmware, or any combination thereof and is capable of performing any of the methods, techniques and/or algorithms described herein.

Additionally, the systems, methods and protocols can be implemented to improve one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can benefit from the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture. It should be noted that a means for processing may be represented by any of the above implementations.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has at least been provided systems and methods for enhanced communications. While the embodiments have been described in conjunction with a number of embodiments, it is evident that many alternatives, modifications and variations would be or are apparent to those of ordinary skill in the applicable arts. Accordingly, this disclosure is intended to embrace all such alternatives, modifications, equivalents and variations that are within the spirit and scope of this disclosure.

1. A wireless communications device comprising:
a controller to:
generate a message with a field, wherein data within the field indicates that the wireless communications device is requesting a measurement report from a responding station (STA);
provide the message for transmission during an announcement transmission interval (ATI);
receive the measurement report;
a wireless radio to:
transmit the message, during the ATI, to the responding STA;
in response to the data within the field, receive the measurement report during the ATI; and
provide the measurement report to the controller.

2. The wireless communications device according to claim 1, wherein the field uses an unused parameter in an existing message sent during the ATI.

3. The wireless communications device of claim 2, wherein the responding STA is forced to send the measurement report, during the ATI, in response to the receiving the field.

4. The wireless communications device of claim 3, wherein the message is not a measurement request message.

5. The wireless communications device of claim 4, wherein the message is an announcement message.

6. The wireless communications device of claim 1, wherein the message is a measurement request message, wherein the field is a measurement token, and wherein the measurement request message does not include at least one of a number of repetitions, an element identifier, a length field, a measurement request mode, a measurement type, or a measurement request field.

7. The wireless communications device of claim 6, wherein the measurement request message does not include any of a number of repetitions, an element identifier, a length field, a measurement request mode, a measurement type, or a measurement request field.

8. The wireless communications device of claim 7, wherein the measurement token indicates which measurement report should be sent by the responding STA.

9. The wireless communications device of claim 1, wherein the field includes an indicator as to whether the wireless communication device, requesting the measurement report, will store the measurement configuration.

10. The wireless communications device of claim 9, wherein, based on the indicator, the responding STA determines whether to include the measurement configuration in the measurement report, wherein the measurement report does not include the measurement configuration.

11. A method comprising:
a controller of a wireless communications device generating a message with a field, wherein data within the field indicates that the wireless communications device is requesting a measurement report from a responding station (STA);
the controller providing the message for transmission during an announcement transmission interval (ATI);
a wireless radio of the wireless communications device transmitting the message, during the ATI, to the responding STA;
in response to the data within the field, the wireless radio receiving the measurement report during the ATI; and
the controller receiving the measurement report from the wireless radio.

12. The method of claim 11, wherein the responding STA is forced to send the measurement report, during the ATI, in response to the receiving the field.

13. The method of claim 12, wherein the field uses an unused parameter in an existing message sent during the ATI, and wherein the message is not a measurement request message.

14. The method of claim 11, wherein the message is a measurement request message, wherein the field is a measurement token, and wherein the measurement request message does not include at least one of a number of repetitions, an element identifier, a length field, a measurement request mode, a measurement type, or a measurement request field, and wherein the measurement token indicates which measurement report should be sent by the responding STA.

15. The method of claim 11, wherein the field includes an indicator as to whether the wireless communication device, requesting the measurement report, will store the measurement configuration, and wherein, based on the indicator, the responding STA determines whether to include the measurement configuration in the measurement report, wherein the measurement report does not include the measurement configuration.

16. A non-transitory information storage media having stored thereon one or more instructions, that when executed by one or more processors, cause a requesting STA to perform a method, the method comprising:
generating a message with a field, wherein data within the field indicates that the wireless communications device is requesting a measurement report from a responding station (STA);
providing the message for transmission during an announcement transmission interval (ATI);
transmitting the message, during the ATI, to the responding STA;
in response to the data within the field, receiving the measurement report during the ATI; and
receiving the measurement report from the wireless radio.

17. The non-transitory information storage media of claim 16, wherein the responding STA is forced to send the measurement report, during the ATI, in response to the receiving the field.

18. The non-transitory information storage media of claim 17, wherein the field uses an unused parameter in an existing message sent during the ATI, and wherein the message is not a measurement request message.

19. The non-transitory information storage media of claim 18, wherein the message is a measurement request message, wherein the field is a measurement token, and wherein the measurement request message does not include at least one of a number of repetitions, an element identifier, a length field, a measurement request mode, a measurement type, or a measurement request field, and wherein the measurement token indicates which measurement report should be sent by the responding STA.

20. The non-transitory information storage media of claim 18, wherein the field includes an indicator as to whether the wireless communication device, requesting the measurement report, will store the measurement configuration, wherein, based on the indicator, the responding STA determines whether to include the measurement configuration in the measurement report, and wherein the measurement report does not include the measurement configuration.
